(19) United States
(12) Patent Application Publication
(10) Pub. No.: US 2007/0088469 A1
(43) Pub. Date: Apr. 19, 2007

(54) VEHICLE CONTROL SYSTEM AND METHOD

(75) Inventors: Gary Schmiedel, Oshkosh, WI (US); Christopher K. Yakes, Oshkosh, WI (US)

Correspondence Address: FOLEY & LARDNER LLP, 777 EAST WISCONSIN AVENUE, MILWAUKEE, WI, 53202-5306, US

(73) Assignee: Oshkosh Truck Corporation

(21) Appl. No.: 11/537,963

(22) Filed: Oct. 2, 2006

Related U.S. Application Data
(60) Provisional application No. 60/723,363, filed on Oct. 4, 2005.

(51) Int. Cl. G01C 22/00

(52) U.S. Cl. 701/23

(57) ABSTRACT

A vehicle control system includes a controller configured to provide an output signal in response to an input signal. The output signal is used to control a vehicle operating parameter. The vehicle control system also includes a simulation module in communication with the controller and configured to execute a vehicle dynamics model to simulate a vehicle response based on the input signal and the vehicle operating parameter. The controller is configured to provide the output signal based on the simulated vehicle response.

### FIELD

The present invention relates generally to vehicle control systems and methods, and particularly to vehicle control systems and methods for controlling autonomous vehicles.

### BACKGROUND

Autonomous and semi-autonomous vehicles are used today in various military and civilian applications. Such autonomous vehicles may include a control system configured to receive information regarding, for example, the surrounding terrain, upcoming obstacles, a particular path, etc., and to automatically respond to this information in place of a human operator by commanding a series of maneuvers so that the vehicle is able to negotiate the terrain, avoid the obstacles, or track a particular path with little or no human intervention. Without the presence of a human operator to assess the ability of the autonomous or semi-autonomous vehicle to complete a particular maneuver, or even with some human intervention, the autonomous or semi-autonomous vehicle may often perform inefficiently, or may attempt maneuvers beyond its capabilities. Thus, there is need for a vehicle control system and method that allows the operating characteristics of autonomous and semi-autonomous vehicles to be maximized while staying within the dynamic capabilities of the vehicle.

### SUMMARY

According to an exemplary embodiment, a vehicle control system includes a controller configured to provide an output signal in response to an input signal. The output signal is used to control a vehicle operating parameter. The vehicle control system also includes a simulation module in communication with the controller and configured to simulate a vehicle dynamics model to determine a vehicle response based on the input signal and the vehicle operating parameter. The controller is configured to provide the output signal based on the simulated vehicle response.

According to another exemplary embodiment, an autonomous vehicle includes an engine, a transmission, a steering system, a braking system, a controller in communication with the engine, the transmission, the steering system, and the braking system, an input sensor configured to provide an input signal to the controller, and a simulation module in communication with the controller and configured to execute a vehicle dynamics model to simulate a vehicle response based on the input signal.

According to another exemplary embodiment, a method of controlling a vehicle includes acquiring an input signal indicative of upcoming terrain from an input sensor, determining a path based on the input signal using the vehicle controller, simulating a vehicle response based on the path and a vehicle operating parameter using a simulation module in communication with the controller and configured to execute a vehicle dynamics model, and providing an output signal to control the vehicle operating parameter based on the simulated vehicle response using the vehicle controller.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings, wherein like numerals depict like elements, and:

FIG. 1 is a block diagram schematically illustrating a vehicle control system according to an exemplary embodiment; and

FIG. 2 is a flow diagram illustrating a method for controlling a vehicle using the system of FIG. 1 according to an exemplary embodiment.

### DETAILED DESCRIPTION

Before turning to the FIGURES which illustrate the exemplary embodiments in detail, it should be understood that the invention is not limited to the details or methodology set forth in the following description or illustrated in the FIGURES. The invention is capable of other embodiments or being practiced or carried out in various ways. It should also be understood that the phraseology and terminology employed herein is for the purpose of description only and should not be regarded as limiting. Further, while the various exemplary embodiments are primarily described in the context of autonomous vehicles, it is to be understood that other types of vehicles are contemplated as well, such as semi-autonomous vehicles and the like. The term “autonomous vehicle” as used herein generally refers to a vehicle configured for unmanned operation, i.e., operation without a human pilot or co-pilot, with some level of autonomy built in, but which may or may not also carry one or more human passengers.

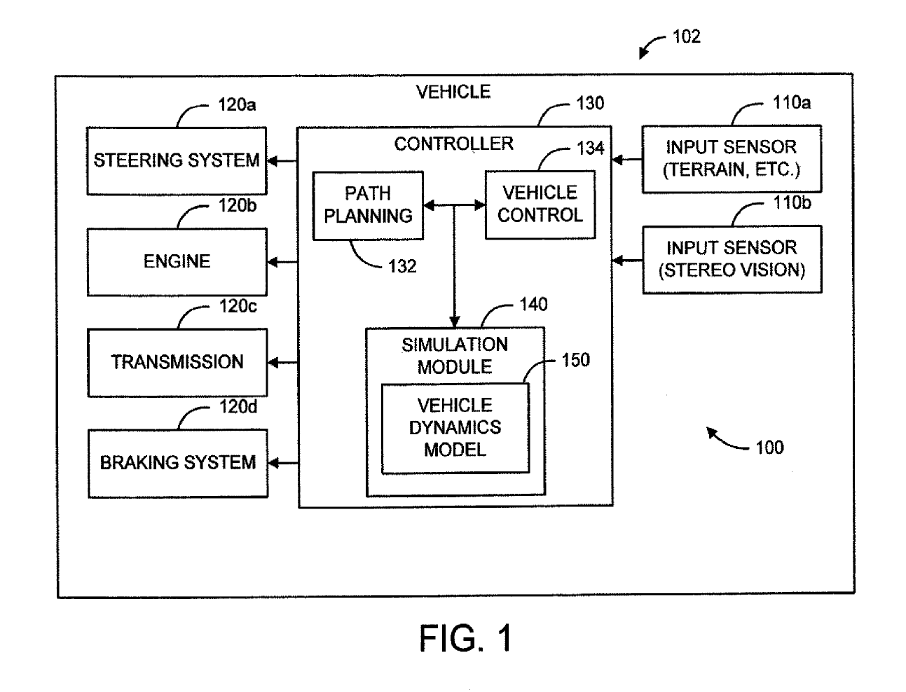

FIG. 1 is a block diagram schematically illustrating a vehicle control system 100 for use with a vehicle 102 according to an exemplary embodiment. Vehicle 102 may be, for example an autonomous or semi-autonomous vehicle configured for military or civilian applications. Vehicle control system 100 includes one or more input sensors 110, one or more output devices 120, a controller 130, and a simulation module 140. Vehicle control system 102 is generally configured to provide output signals to one or more output devices 120 in response to an input signal from one or more input devices 110 to control a vehicle operating parameter. More specifically, vehicle control system 102 is configured to use simulation module 140 to execute a vehicle dynamics model to simulate a vehicle response based on the input signals and the vehicle operating parameter, and to provide the output signals based on the simulated vehicle response.

Input sensor 110 may be any suitable sensor for assessing the surrounding environment of vehicle 102. For example, in the illustrated embodiment, vehicle control system 100 includes a terrain sensor 110a and a stereo vision system 110b. Output devices 120 may be any output device or system used to enable vehicle 102 to execute maneuvers to negotiate terrain, avoid obstacles, track a path, etc. For example, in the illustrated embodiment, vehicle 102 includes steering system 102a, engine 102b, transmission 102c, and braking system 102d.

Controller 130 is generally configured to provide output signals to one or more output devices 120 in response to an input signal from one or more input devices 110 to control a vehicle operating parameter. For example, in the illustrated embodiment, controller 130 is configured to receive input signals from terrain sensor 110a and stereo vision system 110b, and to provide output signals to steering system 102a, engine 102b, transmission 102c, and braking system 102d. Vehicle operating parameters may include, for example, vehicle speed, a vehicle trajectory, vehicle ride quality, vehicle fuel economy, and the like. Controller 130 may include any suitable hardware (e.g., processor and associated components or devices, hardwired control circuitry, etc.), storage devices or media (e.g., EEPROM, magnetic disk, etc.), software and related data structures (e.g., path planning algorithm 132 and vehicle control algorithm 134), or a combination thereof for implementing and executing control functions associated with vehicle 102.

In the illustrated embodiment, controller 130 includes a path planning algorithm 132 and a vehicle control algorithm 134. Path planning algorithm 132 is configured to receive information regarding the surrounding environment of vehicle 102, such as data stored in controller 130 or input signals from one or more input devices 110, and to generate a two-dimensional or three dimensional path. According to an exemplary embodiment, path planning algorithm 132 may be configured to receive a two-dimensional or three-dimensional map generated by controller 130 using a combination of map data stored in controller 130 or received from another location and input signals from terrain sensor 110a and/or stereo vision system 110b regarding upcoming terrain or surrounding obstacles. Path planning algorithm 132 may be further configured to generate a two-dimensional or three dimensional path through the terrain or obstacles represented by the map for vehicle 102 to track.

Vehicle control algorithm 134 is configured to utilize the path generated by path planning algorithm 132 as well as other data regarding vehicle operating parameters to provide output signals to the various output devices 120 (e.g., steering system 102a, engine 102b, transmission 102c, and braking system 102d, etc.) so that vehicle 102 performs the maneuvers required to negotiate the upcoming terrain and track the path while avoiding obstacles as necessary. As will be describe below, controller 130 and vehicle control algorithm 134 are further configured to provide the output signals based on a simulated vehicle response from simulation module 140.

Simulation module 140 is in communication with the controller and may be integrated into controller 140 as shown in FIG. 1 (e.g., as hardware or as software), or may exist as a separate module. Simulation module 140 is configured to execute a vehicle dynamics model 150 to simulate vehicle responses based on the path generated by path planning algorithm 132 and one or more vehicle operating parameters. According to an exemplary embodiment, simulation module 140 is configured to receive a map generated by controller 130 and/or a path generated by path planning algorithm 132 based on input signals from terrain sensor 110a and/or stereo vision system 110b regarding upcoming terrain or surrounding obstacles, as well as one or more values of a vehicle operating parameter from controller 130. In this embodiment, simulation module 140 is further configured to execute vehicle dynamics model 150 using these inputs to simulate one or more vehicle responses.

Vehicle dynamics module 150 may be, for example a data structure existing within a simulation environment, such as an ADAMS vehicle dynamics model configured for use within an ADAMS software simulation environment as provided by MSC Software Corporation of Santa Ana, Calif. Vehicle dynamics module 150 may be representative of various characteristics of vehicle 102, such as vehicle dimensions, vehicle weight, turning radiuses, acceleration and braking capabilities, suspension damping and spring rates, dynamic loads, etc. Within the simulation environment of simulation module 140, a path generated by path generating algorithm 132 may be simulated as a “virtual path,” and vehicle dynamics module 150 may be used to assess the response of a “virtual vehicle” 102 as represented by vehicle dynamics module 150 to various values of a vehicle operating parameter while attempting to track the path.

According to an exemplary embodiment, simulation module 140 may be used to assess the response of a virtual vehicle 102 as represented by vehicle dynamics module 150 over a virtual path to determine of vehicle 102 is capable of successfully traversing the upcoming terrain given a particular value for a vehicle operating parameter. For example, simulation module 140 may receive a path from path planning algorithm 132 indicating a route including an upcoming half-mile unbanked and curved stretch of a dirt road having a six percent uphill grade, and a vehicle speed value of thirty five miles per hour from controller 130. Simulation module 140 may then execute vehicle dynamics model 150 to simulate the response of vehicle 102 over the virtual path to determine, for example, whether traversing the path at a speed of thirty five miles per hour is within the capabilities of vehicle 102.

According to another exemplary embodiment, controller 130 and simulation module 140 may be further configured to iterate a plurality of values for the vehicle operating parameter to determine which, if any, of the values for the vehicle operating parameter will permit vehicle 102 to successfully traverse a particular path over upcoming terrain. For example, simulation module 140 may receive a path from path planning algorithm 132 indicating a route including an upcoming half-mile unbanked and curved stretch of a dirt road having a six percent uphill grade, and vehicle speed values of thirty, thirty five, and forty miles per hour from controller 130. Simulation module 140 may then perform three iterations of executing vehicle dynamics model 150 over the virtual path to simulate the response of vehicle 102 to determine whether traversing the path at any of speeds of thirty, thirty five, and forty miles per hour is within the capabilities of vehicle 102. As a result, simulation module 140 may determine that, for example, vehicle 102 will be able to track the path over the upcoming terrain a speed of thirty miles per hour, but at a speed of thirty five miles per hour, vehicle 102 will not be able to track the curve and will veer off the dirt road, and at a speed of forty miles per hour, vehicle 102 will overturn at the apex of the unbanked curve.

According to another exemplary embodiment, controller 130 and simulation module 140 may be further configured to iterate a plurality of values for a vehicle operating parameter in order to maximize one or more vehicle operating parameters. For example, in the previous example, simulation module 140 may determine that, for example, vehicle 102 will be able to successfully track the path over the upcoming terrain at speeds of thirty, thirty five, and forty miles per hour, but at a speed of thirty five miles per hour, vehicle 102 will achieve maximum fuel economy.

According to another exemplary embodiment, controller 130 and simulation module 140 may be further configured to iterate a plurality of different paths in combination for a value of a vehicle operating parameter to determine which, if any, of the paths may be successfully traversed by vehicle 102 given value of the vehicle operating parameter. For example, simulation module 140 may receive three possible paths from path planning algorithm 132 indicating three alternative routes over upcoming terrain. Simulation module 140 may then perform three iterations of executing vehicle dynamics model 150 over three different virtual paths to simulate the response of vehicle 102 to determine whether traversing any of the three paths at a speed of forty miles per hour is within the capabilities of vehicle 102.

According to another exemplary embodiment, controller 130 and simulation module 140 may be further configured to iterate each of the three possible paths over a plurality of values for a vehicle operating parameter to determine which, if any, of the values for the vehicle operating parameter will permit vehicle 102 to successfully traverse a particular path over upcoming terrain. For example, in the previous example, simulation module 140 may perform three iterations of executing vehicle dynamics model 150 over each of the three different virtual paths to simulate the response of vehicle 102 to determine whether traversing any of the three paths at a speed of thirty, thirty five, or forty miles per hour is within the capabilities of vehicle 102.

According to another exemplary embodiment, controller 130 and simulation module 140 may be further configured to iterate each of the three possible paths over a plurality of values for a vehicle operating parameter in order to maximize one or more vehicle operating parameters. For example, in the previous example, simulation module 140 may perform three iterations of executing vehicle dynamics model 150 over each of the three different virtual paths to simulate the response of vehicle 102 to determine which combination of the three paths with speeds of thirty, thirty five, and forty miles per hour is within the capabilities of vehicle 102 while providing maximum fuel economy.

As mentioned above, controller 130 and vehicle control algorithm 134 are configured to provide the output signals to output devices 120 based on a simulated vehicle response from simulation module 140. Once controller 130 and simulation module have determined a path that may be successfully traversed by vehicle 102 given a particular value for one or more vehicle operating parameters, or have determined maximized values of one or more vehicle operating parameters given the selected path, controller 130 and vehicle control algorithm 134 provide output signals to one or more output devices 120 to command a series of maneuvers so that vehicle 102 tracks the path and/or maximizes the one or more vehicle operating parameters.

According to yet another exemplary embodiment, controller 130 and simulation module 140 are further configured to enhance path planning algorithm 132 by maintaining a look-up table of known types of terrain or obstacles and the ability of vehicle 102 to traverse each type of terrain or obstacle given a particular vehicle operating parameter, such as vehicle speed. Each time an unknown terrain or obstacle type is encountered, controller 130 classifies the terrain or obstacle and stores the result of the simulated vehicle response performed by simulation module 140 in the look-up table. Path planning algorithm 132 may be configured to utilize the look-up table in generating the two-dimensional or three dimensional path through the terrain or obstacles.

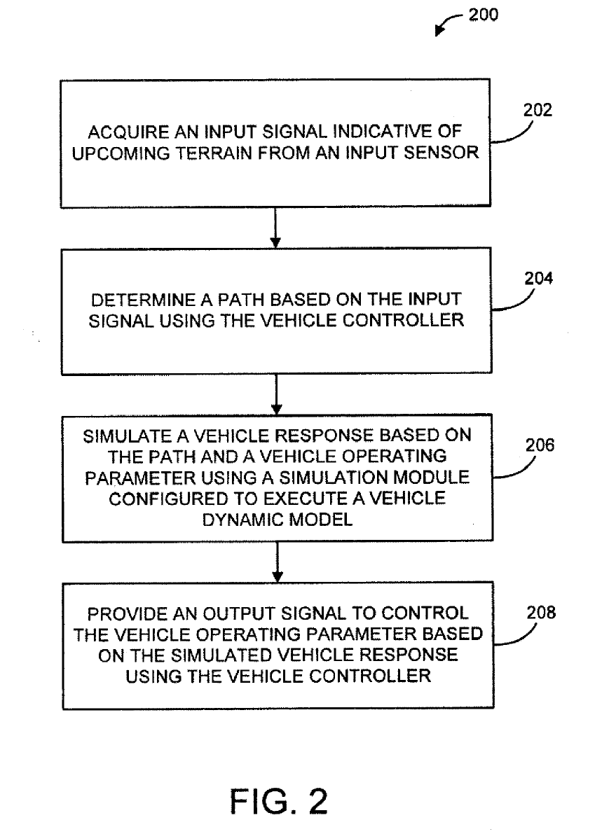

FIG. 2 is a flow diagram illustrating a method 200 for controlling vehicle 102 using vehicle control system 100 according to an exemplary embodiment. Method 200 begins with a step 202. At step 202, an input signal indicative of upcoming terrain is acquired from an input sensor 110. At a step 204, a path based on the input signal using the vehicle controller is determined. At a step 206, a vehicle response is simulated based on the path and a vehicle operating parameter using a simulation module in communication with the controller and configured to execute a vehicle dynamics model. At a step 208, an output signal is provided to control the vehicle operating parameter based on the simulated vehicle response using the vehicle controller.

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the definitions appended hereto and their equivalents.

1. A vehicle control system, comprising:
a controller configured to provide an output signal in response to an input signal, wherein the output signal is used to control a vehicle operating parameter; and
a simulation module in communication with the controller and configured to execute a vehicle dynamics model to simulate a vehicle response based on the input signal and the vehicle operating parameter;
wherein the controller is configured to provide the output signal based on the simulated vehicle response.

2. The vehicle control system of definition 1, wherein the system is configured for use with an autonomous vehicle.

3. The vehicle control system of definition 1, wherein the controller is configured to execute a path planning algorithm and a vehicle control algorithm.

4. The vehicle control system of definition 1, wherein the input signal provides an indication of upcoming terrain.

5. The vehicle control system of definition 1, wherein the vehicle operating parameter is at least one of a vehicle speed, a vehicle trajectory, a vehicle ride quality, and a vehicle fuel economy.

6. The vehicle control system of definition 1, wherein the simulation module is configured to iterate a plurality of values for the vehicle operating parameter to simulate a plurality of vehicle responses.

7. The vehicle control system of definition 6, wherein the controller is configured to maximize the vehicle operating parameter based on the plurality of vehicle responses.

8. An autonomous vehicle, comprising:
an engine;
a transmission;
a steering system;
a braking system;
a controller in communication with the engine, the transmission, the steering system, and the braking system;
an input sensor configured to provide an input signal to the controller; and
a simulation module in communication with the controller and configured to execute a vehicle dynamics model to simulate a vehicle response based on the input signal.

9. The autonomous vehicle of definition 8, wherein the simulation model is further configured to simulate the vehicle response based on a vehicle operating parameter.

10. The autonomous vehicle of definition 9, wherein the controller is configured to provide an output signal to at least one of the engine, the transmission, the steering system, and the braking system to control the vehicle operating parameter based on the simulated vehicle response.

11. The autonomous vehicle of definition 9, wherein the vehicle operating parameter is at least one of a vehicle speed, a vehicle trajectory, a vehicle ride quality, and a vehicle fuel economy.

12. The autonomous vehicle of definition 9, wherein the simulation module is configured to iterate a plurality of values for the vehicle operating parameter to simulate a plurality of vehicle responses.

13. The vehicle control system of definition 9, wherein the controller is configured to maximize the vehicle operating parameter based on the plurality of vehicle responses.

14. The autonomous vehicle of definition 8, wherein the input signal provides an indication of upcoming terrain.

15. The autonomous vehicle of definition 8, wherein the controller is configured to execute a path planning algorithm and a vehicle control algorithm.

16. A method of controlling a vehicle, comprising:
acquiring an input signal indicative of upcoming terrain from an input sensor;
determining a path based on the input signal using the vehicle controller;
simulating a vehicle response based on the path and a vehicle operating parameter using a simulation module in communication with the controller and configured to execute a vehicle dynamics model; and
providing an output signal to control the vehicle operating parameter based on the simulated vehicle response using the vehicle controller.

17. The method of definition 16, wherein the vehicle operating parameter is at least one of a vehicle speed, a vehicle trajectory, a vehicle ride quality, and a vehicle fuel economy.

18. The method of definition 16, wherein simulating the vehicle response comprises iterating a plurality of values for the vehicle operating parameter to simulate a plurality of vehicle responses.

19. The method of definition 18, wherein the controller is configured to maximize the vehicle operating parameter based on the plurality of vehicle responses.

20. The method of definition 16, wherein the vehicle is an autonomous vehicle.
